(19) United States
(12) Patent Application Publication
(10) Pub. No.: US 2013/0304470 A1
(43) Pub. Date: Nov. 14, 2013

(54) ELECTRONIC DEVICE AND METHOD FOR DETECTING PORNOGRAPHIC AUDIO DATA

(71) Applicant: HON HAI PRECISION INDUSTRY CO., LTD., New Taipei (TW)

(72) Inventor: CHUN-TE WU, New Taipei (TW)

(73) Assignee: HON HAI PRECISION INDUSTRY CO., LTD., New Taipei (TW)

(21) Appl. No.: 13/892,290

(22) Filed: May 12, 2013

(30) Foreign Application Priority Data
May 11, 2012 (CN) 2012101462808

(51) Int. Cl. G10L 25/90

(52) U.S. Cl. CPC G10L 25/90
USPC 704/239

(57) ABSTRACT

An electronic device used for detecting pornographic audio contents includes a memory, a reading module, a calculating module, a comparing module, and a determining module. The memory stores multiple sample curves of pornographic audio contents. The reading module accesses audio contents from an audio/video source. The calculating module calculates a plurality of pitch curves of the audio contents. The comparing module compares the pitch curves of the audio contents with the sample curves of pornographic audio contents to gain similarities of the pitch curves and the sample curves of pornographic audio contents. The determining module determines whether the audio contents are pornographic audio contents according to the similarities.

### BACKGROUND

1. Technical Field

The present disclosure relates to audio processing, and more particularly to an electronic device and a method for detecting pornographic audio contents.

2. Description of Related Art

Electronic communication networks are a part of many people's personal and working lives. Learning skills and information can be readily retrieved from various communication networks. Unhealthy multimedia contents, for example, pornography, can also be obtained from networks. Such multimedia contents may be associated with criminality and be adverse to social order. In particular, unwholesome multimedia contents can be injurious to teenagers.

Current methods for electronically detecting pornographic audio detect both the images and sounds of multimedia contents, typically by using complicated algorithms. This is time-consuming. Thus, a simple and rapid means and method for detecting pornographic audio contents are desired.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a block diagram of an exemplary embodiment of an electronic device in accordance with the present disclosure.

FIG. 2 is a flowchart of an exemplary embodiment of a method for detecting pornographic audio contents applied to an electronic device in accordance with the present disclosure.

FIG. 3 is a flowchart of an exemplary embodiment of further processing implemented to accessed audio contents in accordance with the present disclosure.

FIG. 4 is a schematic audio waveform diagram of further processing implemented to suspicious audio slides obtained in the further processing of FIG. 3, in accordance with the present disclosure.

FIG. 5 is a schematic audio waveform diagram of further processing for calculating pitch curves in accordance with the suspicious audio slides, in accordance with the present disclosure.

FIG. 6 is a pair of schematic graphs showing a range of a female pitch frequency reserved in accordance with the present disclosure.

FIGS. 7a and 7b are each a group of schematic graphs showing pitch curves having high similarities with sample curves in accordance with the present disclosure.

FIG. 8 is a pair of schematic graphs showing further processing implemented to a discontinuous pitch curve in order to generate a complete pitch curve, in accordance with the present disclosure.

FIG. 9 is a detailed flowchart of step S400 of FIG. 2, in accordance with the present disclosure.

FIG. 10 is a detailed flowchart of one embodiment of implementing step S500 of FIG. 2, in accordance with the present disclosure.

FIG. 11 is a group of schematic graphs showing pornographic index calculation and determination in accordance with the present disclosure.

### DETAILED DESCRIPTION

The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references can mean “at least one.”

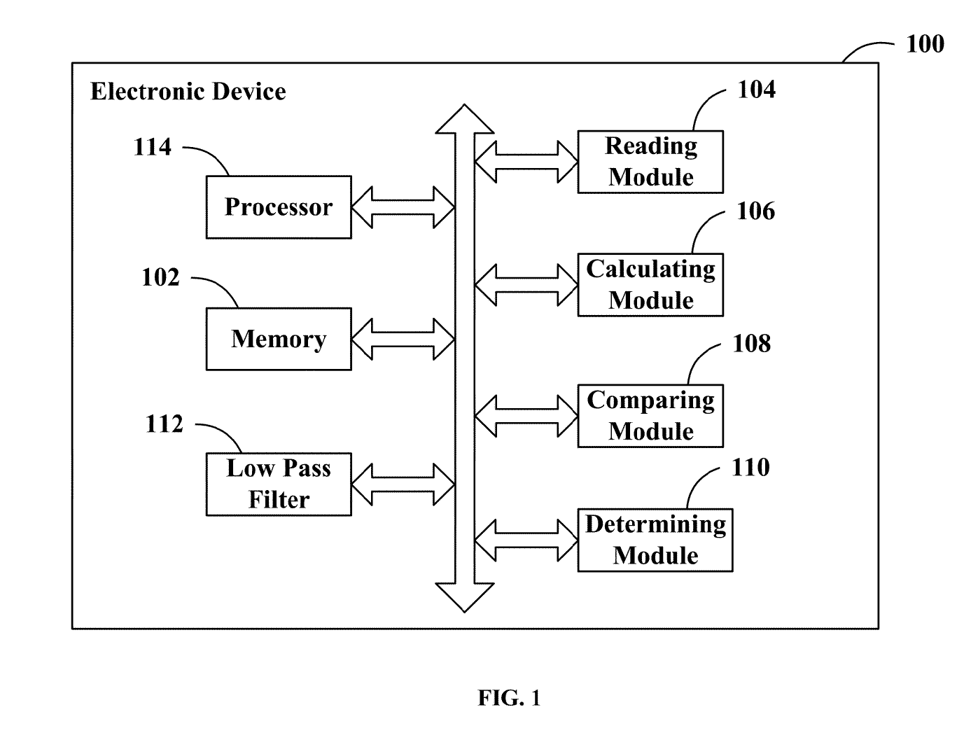

Referring to FIG. 1, an exemplary embodiment of an electronic device 100 of the present disclosure can be a recreational product such as a cell phone, a video player, a tablet computer, a loudspeaker or a set-top box, or a video conference device associated with MSN™, SKYPE™ or QQ™. In an embodiment of the present disclosure, the electronic device 100 stores sample curves of pornographic audio contents. When an audio play starts, the electronic device 100 accesses audio contents from an audio/video source and calculates multiple sound pitch curves of the audio contents. The electronic device 100 compares the calculated pitch curves and the sample curves of pornographic audio contents one by one, gains similarities of the calculated pitch curves and the sample curves, and determines whether the audio contents include pornographic audio contents according to the similarities. In the following description, unless the context indicates otherwise, an “audio/video source” includes either or both of an audio source and a video source having audio content.

In an embodiment of the present disclosure, the electronic device 100 comprises a processor 114, a memory 102, a reading module 104, a calculating module 106, a comparing module 108 and a determining module 110. The memory 102 stores multiple sample curves of pornographic audio contents. In an embodiment of the present disclosure, the memory 102 is hardware for storing data, such as a Flash memory, a hard disk, or a buffer. The processor 114 reads program codes designed for the reading module 104, the calculating module 106, the comparing module 108 and the determining module 110, for implementing functions of those modules.

The reading module 104 accesses audio contents from an audio/video source, and stores the audio contents in the memory 102. In an embodiment of the present disclosure, the memory 102 comprises an audio buffer configured to store audio contents accessed by the reading module 104. In an embodiment of the present disclosure, the reading module 104 downloads audio/video contents from a network (for example the Internet), accesses audio/video files stored in the electronic device 100, or retrieves on-line audio/video streams or on-line radio streams.

The reading module 104 copies the audio contents, filters a high frequency portion of the copied audio contents using a low pass filter 112, and retrieves a low-frequency energy distribution of the copied audio contents by calculating an absolute value of the remaining portion of the copied audio contents. The reading module 104 analyzes volume distribution sections of the low-frequency energy distribution, and removes first volume distribution sections from the volume distribution sections, wherein the first volume distribution sections each have less than a predetermined volume threshold value. The reading module 104 removes second volume distribution sections from the remaining volume distribution sections without the first volume distribution sections, wherein each of continuing time slots of the second volume distribution sections is not located within a preset time range. The reading module 104 extracts multiple suspicious audio slides from the remaining volume distribution sections without the first and second volume distribution sections, for subsequent processing. The predetermined volume threshold value is, for example, 10% of the maximum volume level; and the preset time range is, for example, 0.4-1.2 seconds.

The calculating module 106 calculates multiple pitch curves representing frequency distributions according to the audio contents accessed by the reading module 104. In an embodiment of the present disclosure, the calculating module 106 calculates pitch curves based on audio contents, directly accessed by the reading module 104, or based on suspicious audio slides, which have been further processed. The calculating module 106 calculates multiple pitch curves of audio contents using an Autocorrelation Function (ACF) algorithm. In an exemplary embodiment of the present disclosure, the calculating module 106 removes frequency dots located beyond a range of a female pitch frequency from the pitch curves. The comparing module 108 compares each of the pitch curves with the sample curves of pornographic audio contents one by one to gain multiple sets of similarities between each of the pitch curves and the sample curves, and obtains maximum similarity values of the multiple sets of similarities. In an embodiment of the present disclosure, the comparing module 108 directly compares the accessed pitch curves with the sample curves of pornographic audio contents stored in the memory 102 one by one. In another embodiment of the present disclosure, the comparing module 108 further processes the accessed pitch curves to generate complete pitch curves, and compares the complete pitch curves with the sample curves of pornographic audio contents stored in the memory 102 one by one. In an embodiment of the present disclosure, the comparing module 108 determines whether there are any pitch curves not accessed; and, if the determination is yes, accesses the next pitch curve for another processing, until all of the pitch curves are compared.

When all of the pitch curves are compared, the determining module 110 determines whether the audio contents are pornographic audio contents according to the maximum similarity values calculated by the comparing module 108. In an embodiment of the present disclosure, when a maximum similarity value is greater than a base value, for example 90%, the audio contents corresponding to the maximum similarity value are determined as being pornographic audio contents. Otherwise, the audio contents are determined as not being pornographic audio contents. In an embodiment of the present disclosure, the determining module 110 determines whether accessed audio contents are pornographic audio contents according to the number of pornographic curves. In another embodiment of the present disclosure, the determining module 110 determines whether accessed audio contents are pornographic audio contents by processing the maximum similarity values in other ways. The determining module 110 compares each of the maximum similarity values with the preset base value to select first maximum similarity values greater than the preset base value, and calculates pornographic indexes for each of the first maximum similarity values. The determining module 110 implements a functional operation, for example an exponential function or a linear function, to the pornographic indexes and determines whether the accessed audio contents are pornographic audio contents. In an embodiment of the present disclosure, when the functional operation result of the pornographic indexes is greater than a predetermined index threshold value, for example 100%, the accessed audio contents are determined as being pornographic audio contents. Details of the functional operations and determinations of the pornographic audio contents are described below.

In an embodiment of the present disclosure, the determining module 110 executes corresponding actions according to the pornographic contents. Such actions can be, for example, interrupting an output of audio/video contents, muting the audio signals and interrupting the video signals, or terminating a video play application. In another embodiment of the present disclosure, the determining module 110 sets corresponding conditions to terminate the audio muting action and the video interrupting action. Such setting of corresponding conditions can be, for example, recovering the audio/video signals to a normal display after a predetermined time period has passed.

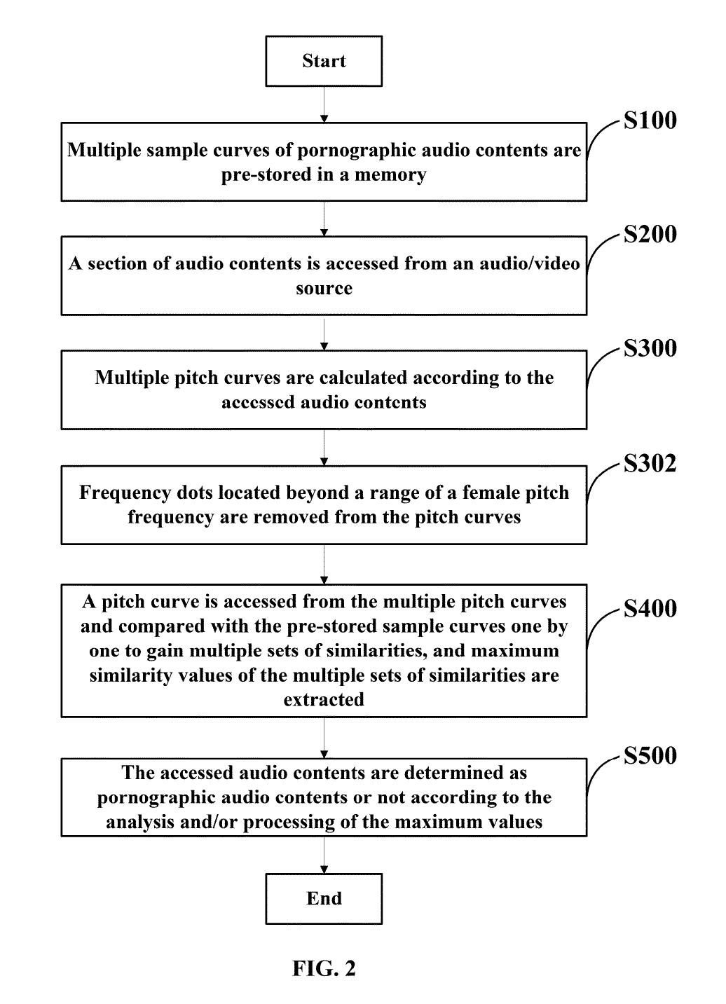

Referring to FIG. 2, an embodiment of a method for detecting pornographic audio contents applied to an electronic device 100 is provided. The method is implemented using the functional modules shown in FIG. 1.

In step S100, multiple sample curves of pornographic audio contents are pre-stored in the memory 102. In step S200, the reading module 104 accesses a section of audio contents from an audio/video source.

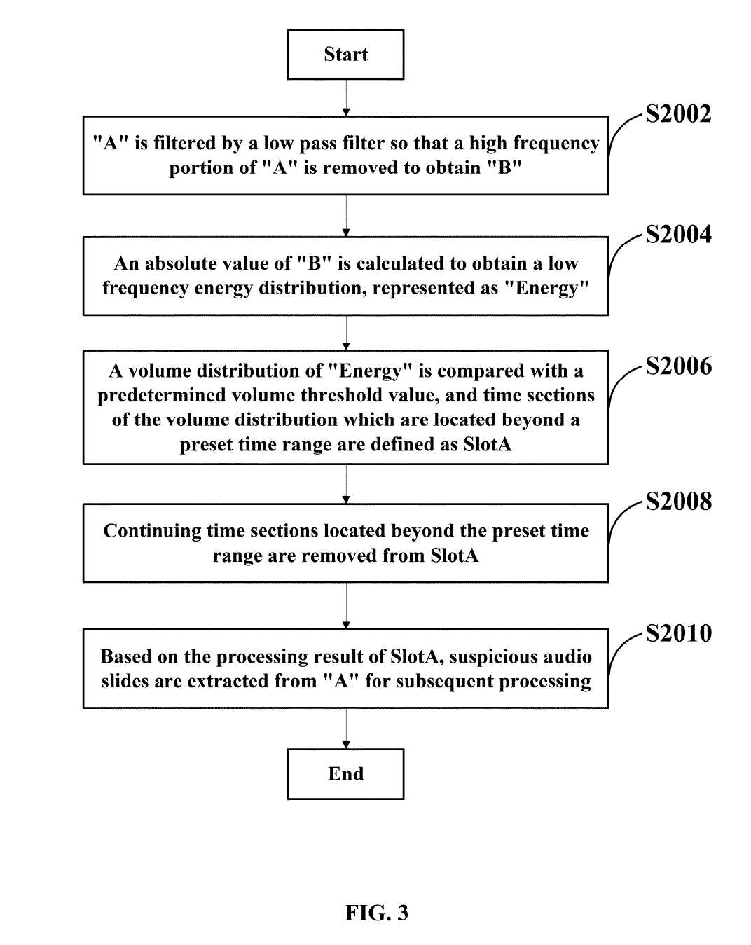

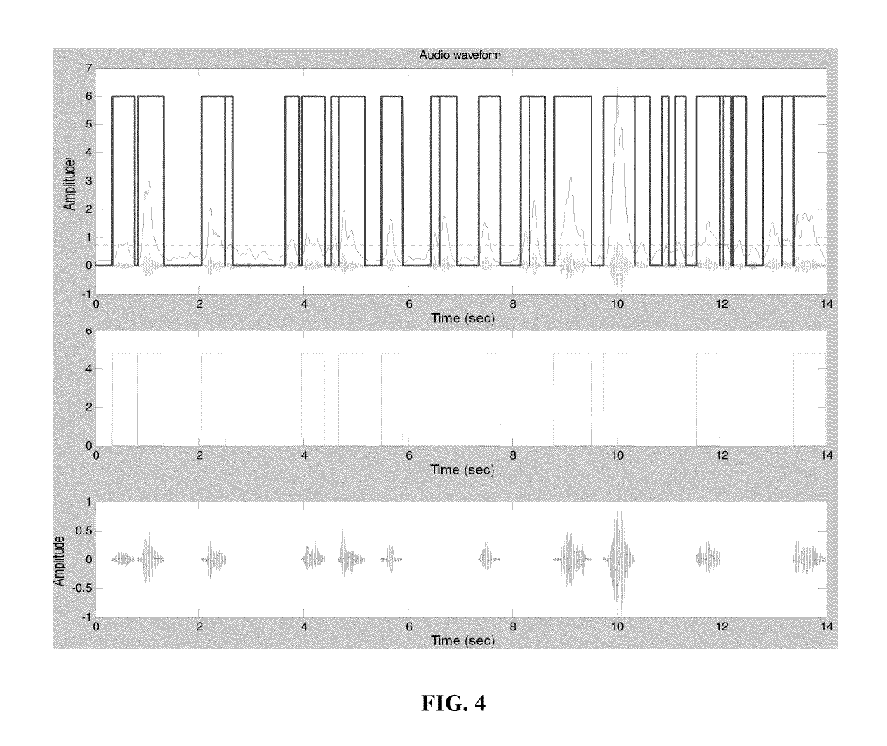

Referring to FIG. 3, a flowchart of further processing implemented to the audio contents accessed by the reading module 104 is provided. In FIG. 3, “A” represents an array of the audio contents accessed by the reading module 104, while “B” represents an array of the audio contents in which a high frequency portion is filtered out. In step S2002, “A” is filtered by a low pass filter 112 so that a high frequency portion of “A” is removed to obtain “B.” In step S2004, an absolute value of “B” is calculated to obtain a low frequency energy distribution, represented as “Energy.” In step S2006, a volume distribution of “Energy” is compared with a predetermined volume threshold value; and time sections of the volume distribution which are located beyond a preset time range are defined as SlotA. In step S2008, continuing time sections located beyond the preset time range are removed from SlotA. In an embodiment of the present disclosure, the preset time range is defined as 0.4-1.2 seconds; thus, continuing time sections less than 0.4 seconds or greater than 1.2 seconds are removed. In step S2010, based on the processing result of SlotA, suspicious audio slides are extracted from “A” for subsequent processing. Referring to FIG. 4, a schematic audio waveform diagram of further processing implemented to the suspicious audio slides is provided. As shown in FIG. 4, only the suspicious audio slides are processed for simplification so as to save resources of a central processing unit, such as the processor 114.

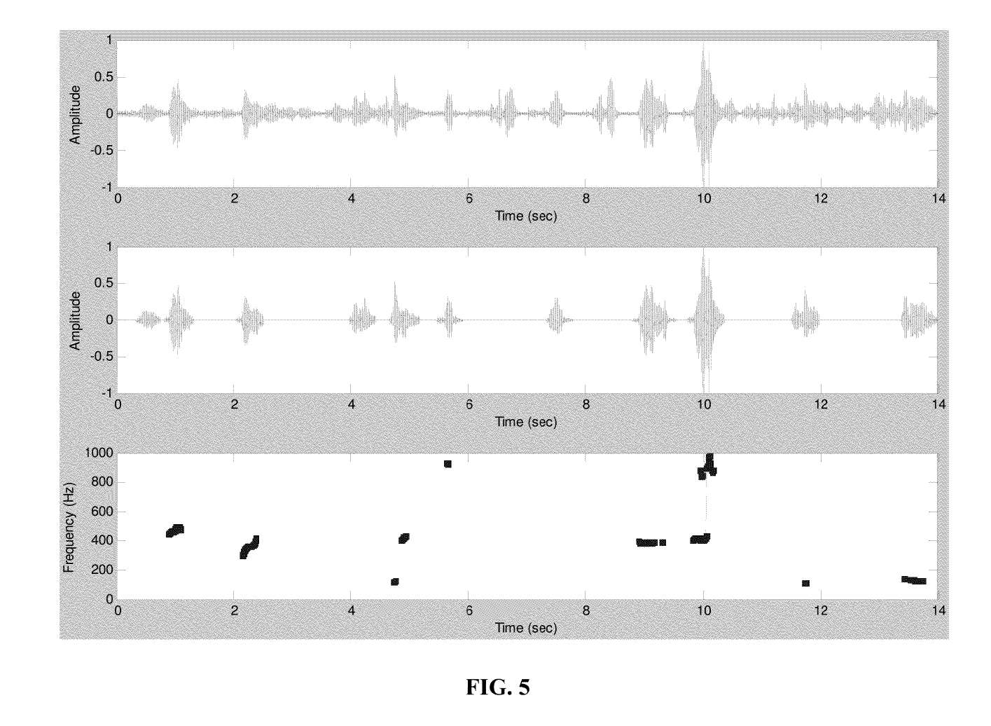

Referring to FIG. 2 again, in step S300, the calculating module 106 calculates multiple pitch curves representing frequency distributions according to the audio contents accessed by the reading module 104. In an embodiment of the present disclosure, the calculating module 106 calculates the pitch curves according to the audio contents directly accessed by the reading module 104 or according to the suspicious audio slides, by way of further processing. The pitch curves may be processed using the ACF algorithm, which is well known and is not further described herein. Referring to FIG. 5, a schematic waveform diagram of further processing for calculating pitch curves in accordance with the suspicious audio slides is provided. As shown in FIG. 5, a pitch curve is generated for each of the suspicious audio slides.

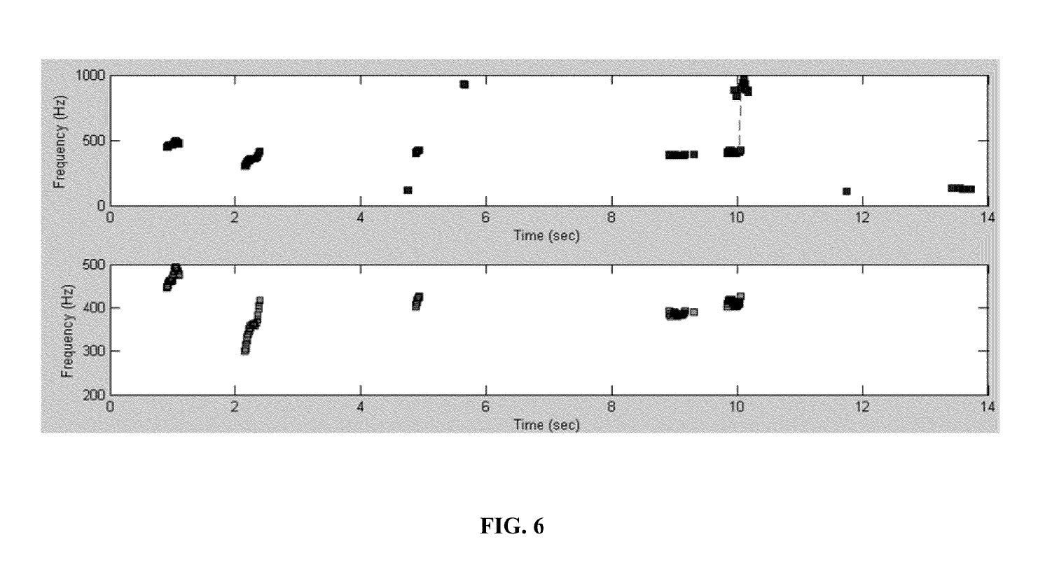

In another embodiment of the present disclosure, in an additional step S302 of FIG. 2, the calculating module 106 removes frequency dots located beyond a range of a female pitch frequency, namely 200 Hz-550 Hz, from the pitch curves representing the frequency distributions. Referring to FIG. 6, a pair of schematic graphs showing a range of a female pitch frequency reserved is provided. In each of the graphs, frequency dots located within a range of a male pitch frequency are removed. Accordingly, only the pitch curves representing female voice (groans) are processed and compared to save resources of a processor, such as the processor 114.

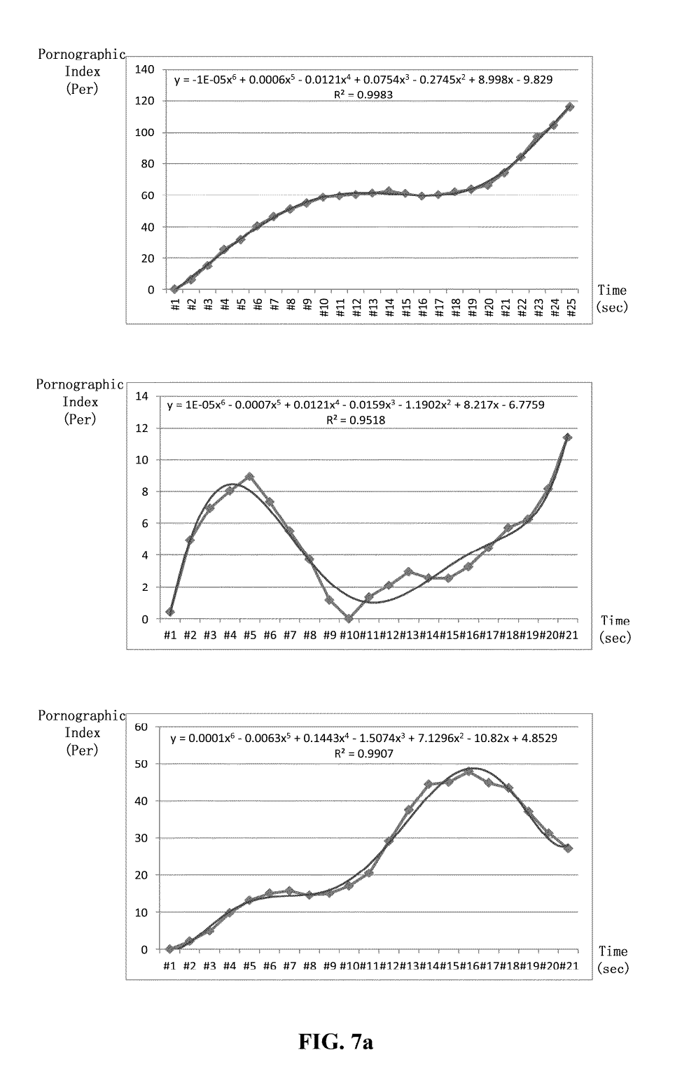

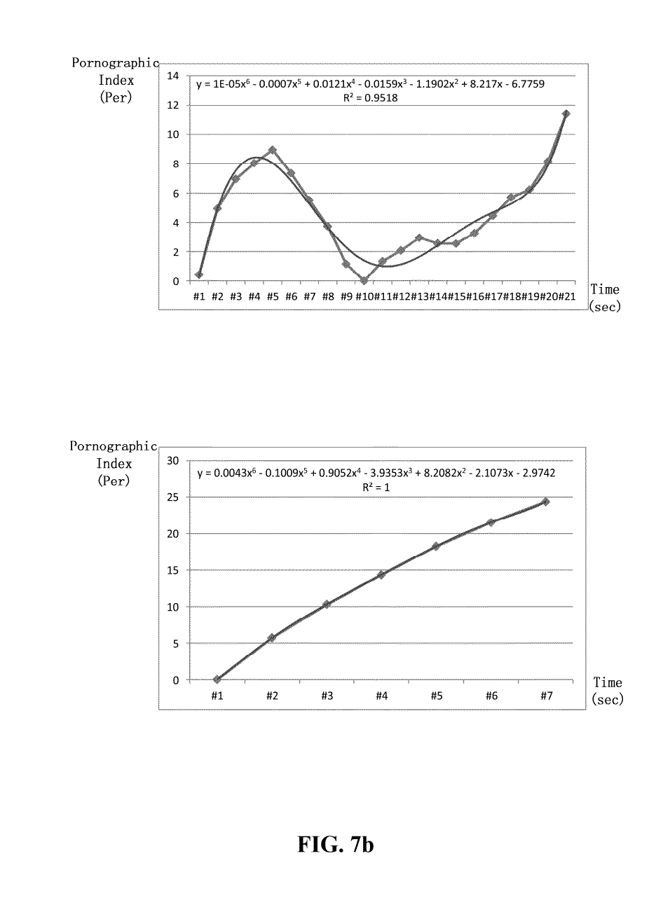

Referring to FIG. 2 again, in step S400, the comparing module 108 accesses a pitch curve from the multiple pitch curves and compares the accessed pitch curve with the sample curves of pornographic audio contents stored in the memory 102 one by one, to gain multiple sets of similarities between each of the pitch curves and the sample curves. The comparing module 108 extracts maximum similarity values of the multiple sets of similarities, and determines whether a pitch curve corresponding to a maximum similarity value is a pornographic curve. The similarity indicates resemblance between a pitch curve and a sample curve, and is calculated by coefficient determination. In the present disclosure, the similarity is expressed by R²; while a complete similarity is represented by R²=100%. Referring to FIGS. 7a and 7b, schematic graphs showing pitch curves having high similarities with sample curves are provided.

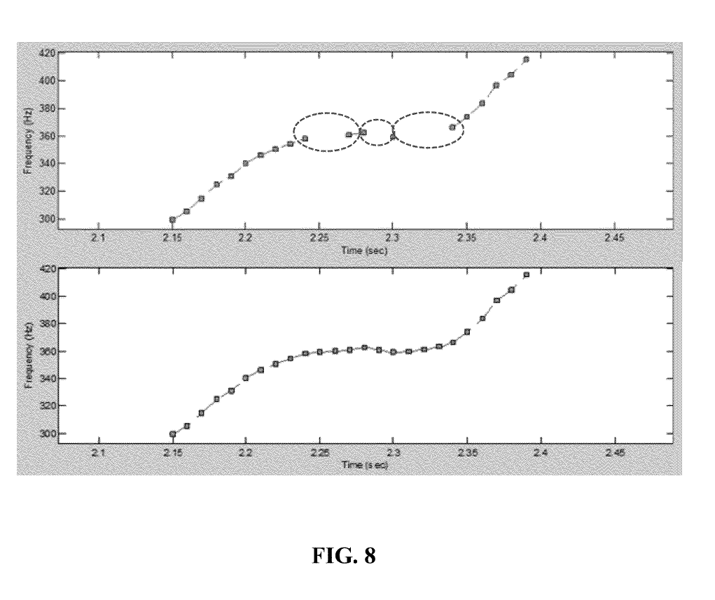

In an embodiment of the present disclosure, the comparing module 108 directly compares accessed pitch curves with the sample curves of pornographic audio contents stored in the memory 102 one by one. In another embodiment of the present disclosure, the comparing module 108 further processes the accessed pitch curves to obtain complete pitch curves, and compares the complete pitch curves with the sample curves of pornographic audio contents stored in the memory 102 one by one. Referring to FIG. 8, a pair of schematic graphs showing further processing implemented to a discontinuous pitch curve in order to generate a complete pitch curve are provided. When a pitch curve comprises gaps, such as the lack of frequency dots, frequency dots are inserted into the pitch curve using an interpolation algorithm according to the trend of the pitch curve. Thereby, a complete pitch curve with integrity is obtained.

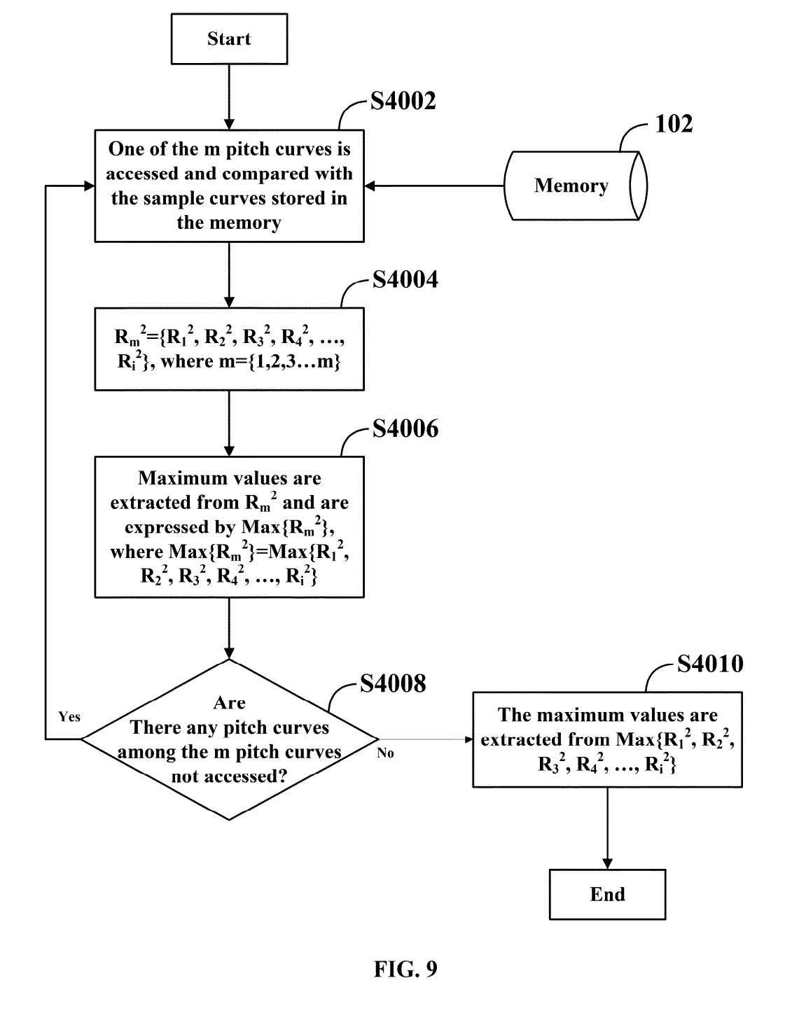

Referring to FIG. 9, a detailed flowchart of step S400 shown in FIG. 2 is provided. In an embodiment of the present disclosure, the number of pitch curves is represented by “m” and the number of sample curves of pornographic audio contents stored in the memory 102 is represented by “i.” As shown in FIG. 9, in step S4002, the comparing module 105 accesses one of the m pitch curves and compares the accessed pitch curve with the sample curves stored in the memory 102. In step S4004, Rₘ²={R₁², R₂², R₃², R₄², . . . , Rᵢ²}, where m={1,2,3 . . . m}. In step 4006, the comparing module 108 extracts maximum values from Rₘ², expressed as Max{Rₘ²}, where Max{Rₘ²}=Max{R₁², R₂², R₃², R₄², . . . , Rᵢ²}. In step S4008, the comparing module 108 determines whether there are any pitch curves among the m pitch curves not accessed. If there is any pitch curve not accessed, the process proceeds to step S4002 for processing another pitch curve. If all of the pitch curves are completely compared, the process proceeds to step S4010 for extracting the maximum values from Max{R₁², R₂², R₃², R₄², . . . , Rᵢ²}.

Referring to FIG. 2 again, in step S500, the determining module 110 determines whether the accessed audio contents are pornographic audio contents according to an analysis and/or processing of the maximum values. In an embodiment of the present disclosure, when the maximum value is greater than a preset base value, the accessed pitch curve is determined as being a pornographic curve. In one example, when the base value is set as 90%, and when R² is less than 90%, then the pitch curve is considered not to be a pornographic curve. In an embodiment of the present disclosure, the determining module 110 determines whether the accessed audio contents are pornographic audio contents according to the number of pornographic curves. In one example, even if only one pornographic curve is detected, for example, the accessed audio contents are still determined as being pornographic audio contents. In another embodiment of the present disclosure, the determining module 110 determines whether the accessed audio contents are pornographic audio contents by processing the maximum values in other ways.

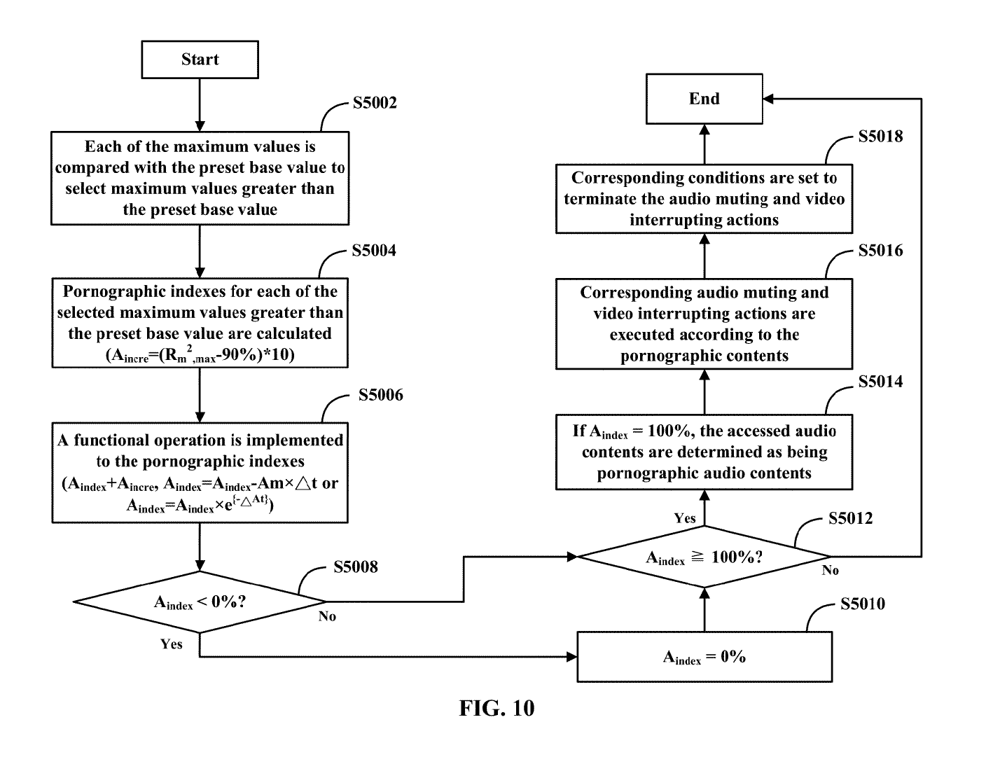

Referring to FIG. 10, a detailed flowchart of one embodiment of implementing step S500 shown in FIG. 2 is provided. In step S5002, the determining module 110 compares each of the maximum values with the preset base value to select maximum values greater than the preset base value. In step S5004, the determining module 110 calculates pornographic indexes for each of the selected maximum values greater than the preset base value. The pornographic index for each of such selected maximum values can be calculated by the equation A_{incre}=(R_{m,max}²−90%)*10, where A_{incre} indicates the pornographic index. According to this equation, the pornographic index is incremented by 10% whenever the maximum similarity increases 1%. Accordingly, “m” pornographic indexes, each designated as A_{incre}, can be calculated via the equation A_{incre}=(R_{m,max}²−90%)*10.

In step S5006, the determining module 110 implements a functional operation to the pornographic indexes for determining whether the accessed audio contents are pornographic audio contents. In an embodiment of the present disclosure, when the functional operation result of the pornographic indexes is greater than a predetermined index threshold value, for example 100%, the accessed audio contents are determined as being pornographic audio contents. The functional operation may be a linear function, A_{index}=A_{index}−Am×Δt, or an exponential function, A_{index}=A_{index}×e^{{-ΔAt}}. In an embodiment of the present disclosure, the generated m A_{incre} pornographic indexes are added to A_{index} and are calculated via the linear function A_{index}=A_{index}−Am×Δt or the exponential function, A_{index}=A_{index}×e^{{-ΔAt}}. A_{index} indicates an accumulator, and a value of A_{index} is located in the range of from 0% to 100%.

In step S5008, the determining module 110 determines whether A_{index} is less than 0%. In step S5010, if A_{index} is less than 0%, A_{index} is always considered to be equal to 0%. In step S5012, if A_{index} is not less than 0%, the determining module 110 determines whether A_{index} is greater than or equal to 100%. In step S5014, if A_{index} is greater than or equal to 100%, A_{index} is always considered to be equal to 100%. When A_{index} is greater than the preset index threshold value, 100%, the audio contents accessed by the determining module 110 are determined as being pornographic audio contents.

In step S5016, the determining module 110 executes corresponding actions according to the pornographic contents. Such actions can be, for example, interrupting an output of audio/video contents, muting the audio signals and interrupting the video signals, or terminating a video play application. In step S5018, the determining module 110 sets corresponding conditions to terminate the audio muting action and the video interrupting action. Such setting of corresponding conditions can be, for example, recovering the audio/video signals to a normal display after a predetermined time period has passed.

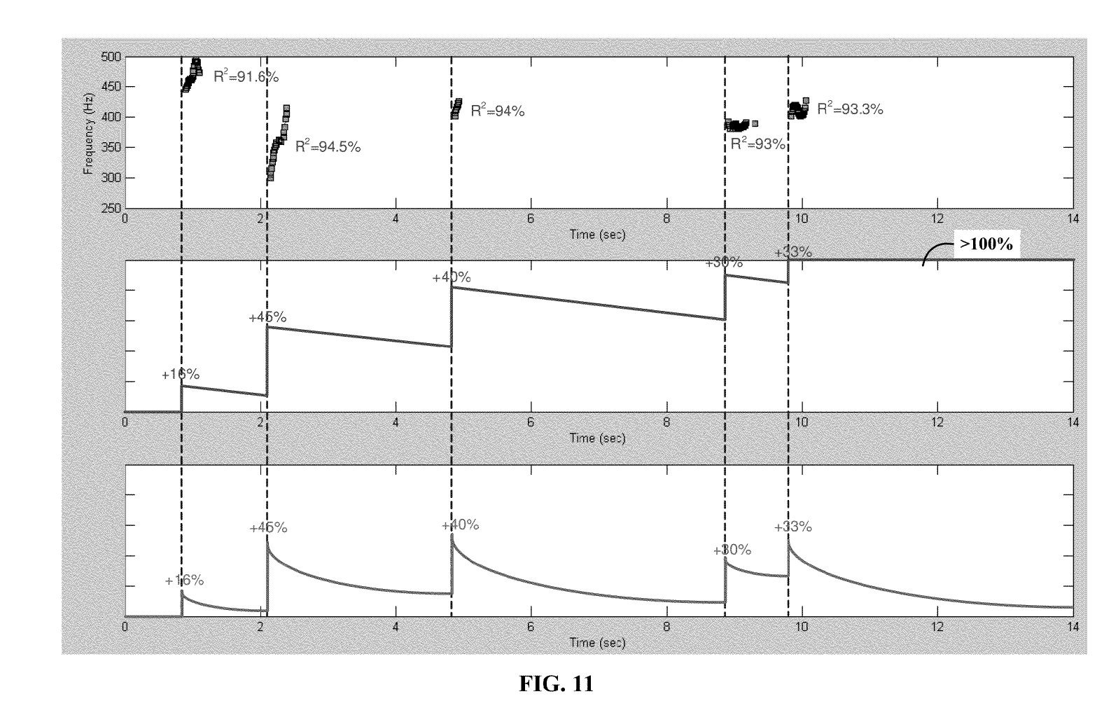

Referring to FIG. 11, a schematic diagram of pornographic index calculation and determination is provided, which shows that pornographic indexes of each pitch curve decreased progressively over time and an accumulation of the pornographic indexes. The symbol “>100%” marked beside the audio sections indicates that the accumulation exceeds the preset index threshold value, 100%, and, at the time period of the audio sections, the audio/video output is interrupted.

In summary, an exemplary embodiment of a method for detecting pornographic audio data of the present disclosure analyzes only audio contents from multimedia data, and rapidly and effectively determines whether accessed multimedia contents are pornographic contents in a way whereby resources of a processor can be saved.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

What is claimed is:

1. An electronic device, comprising:
a memory configured to store multiple sample curves of pornographic audio contents;
a reading module configured to access audio contents from an audio/video source;
a calculating module configured to calculate a plurality of pitch curves of the audio contents;
a comparing module configured to compare the pitch curves of the audio contents with the sample curves of pornographic audio contents to gain similarities of the pitch curves and the sample curves of pornographic audio contents; and
a determining module configured to determine whether the audio contents include pornographic audio contents according to the similarities.

2. The electronic device of claim 1, wherein the reading module copies the audio contents, filters a high frequency portion of the copied audio contents via a low-pass filter, and retrieves low-frequency energy distribution of the copied audio contents by calculating an absolute value of the remaining portion of the copied audio contents.

3. The electronic device of claim 2, wherein the reading module analyzes volume distribution sections of the low-frequency energy distribution, removes first volume distribution sections that each less than a volume threshold from the volume distribution sections, removes second volume distribution sections from the volume distribution sections without the first volume distribution sections, wherein each of continuing time slots of the second volume distribution sections is not located within a preset time range, extracts multiple suspicious audio slides from the remaining portion of the volume distribution sections, and transmits the suspicious audio slides to the calculating module for calculating the pitch curves.

4. The electronic device of claim 1, wherein the calculating module removes frequency dots locating beyond a range of a female pitch frequency from the pitch curves.

5. The electronic device of claim 1, wherein the comparing module inserts frequency dots to a pitch curve using an Interpolation algorithm for integrity and gains a similarity of the integrated pitch curve.

6. The electronic device of claim 1, wherein the comparing module accesses one of the pitch curves and compares the accessed pitch curve with the sample curves of pornographic audio contents one by one to gain multiple sets of similarities, extracts a maximum similarity value from the multiple sets of similarities, and determines whether the accessed pitch curve is a pornographic curve according to the maximum similarity value.

7. The electronic device of claim 6, wherein the comparing module determines whether there are un-accessed pitch curves, proceeds to accessing the next pitch curve to be compared if there is any un-accessed pitch curve, and determines whether the accessed pitch curve is a pornographic curve according to the maximum similarity value.

8. The electronic device of claim 7, wherein the determining module calculates a pornographic index based on maximum similarity values of multiple sets of similarities of each of the pitch curves, and compares the pornographic index with a preset index threshold value to determine whether the audio contents are the pornographic audio contents.

9. The electronic device of claim 8, wherein the determining module automatically interrupts an output of audio/video signals when the pornographic index exceeds the preset index threshold value.

10. The electronic device of claim 8, wherein the determining module extracts maximum similarity values of multiple sets of similarities from each of the pitch curves, calculates pornographic indexes for each of the maximum similarity values, and accumulates the pornographic indexes to obtain an accumulated value.

11. A method for detecting pornographic audio contents using an electronic device, the method comprising:
pre-storing multiple sample curves of pornographic audio contents in a memory;
accessing audio contents from an audio/video source;
calculating a plurality of pitch curves of the audio contents;
comparing the pitch curves of the audio contents with the sample curves of pornographic audio contents to gain similarities of the pitch curves and the sample curves of pornographic audio contents; and
determining whether the audio contents include pornographic audio contents according to the similarities.

12. The method of claim 11, wherein accessing the audio contents from an audio/video source comprises:
copying the audio contents;
filtering a high frequency portion of the copied audio contents via a low-pass filter; and
retrieving low-frequency energy distribution of the copied audio contents by calculating an absolute value of the remaining portion of the copied audio contents.

13. The method of claim 12, wherein accessing the audio contents from an audio/video source further comprises:
analyzing volume distribution sections of the low-frequency energy distribution;
removing first volume distribution sections that each less than a volume threshold from the volume distribution sections;
removing second volume distribution sections from the volume distribution sections without the first volume distribution sections, wherein each of continuing time slots of the second volume distribution sections is not located within a preset time range; and
extracting multiple suspicious audio slides from the remaining portion of the volume distribution sections for calculating the pitch curves.

14. The method of claim 11, further comprising removing frequency dots locating beyond a range of a female pitch frequency from the pitch curves.

15. The method of claim 11, further comprising inserting frequency dots to a pitch curve using an Interpolation algorithm for integrity and gains a similarity of the integrated pitch curve.

16. The method of claim 11, wherein determining whether the audio contents include pornographic audio contents according to the similarities comprises:
accessing one of the pitch curves;
comparing the accessed pitch curve with the sample curves of pornographic audio contents one by one to gain multiple sets of similarities;
extracting a maximum similarity value from the multiple sets of similarities;
determining whether the accessed pitch curve is a pornographic curve according to the maximum similarity value;
determining whether there is any pitch curve not accessed;
proceeding to accessing the next pitch curve to be compared if there is a pitch curve not accessed; and
determining whether the accessed pitch curve is a pornographic curve according to the maximum similarity value.

17. The method of claim 16, wherein determining whether the accessed pitch curve is a pornographic curve according to the maximum similarity value comprises:
calculating a pornographic index based on maximum similarity values of multiple sets of similarities of each of the pitch curves; and
comparing the pornographic index with a preset index threshold value to determine whether the audio contents are the pornographic audio contents.

18. The method of claim 17, further comprising automatically interrupting an output of audio/video signals when the pornographic index exceeds the preset index threshold value.

19. The method of claim 17, wherein calculating a pornographic index based on maximum similarity values of multiple sets of similarities of each of the pitch curves comprises:
extracting maximum similarity values of multiple sets of similarities from each of the pitch curves;
calculating pornographic indexes for each of the maximum similarity values; and
accumulating the pornographic indexes to obtain an accumulated value.
